(19) United States
(12) Patent Application Publication
(10) Pub. No.: US 2025/0103973 A1
(43) Pub. Date: Mar. 27, 2025

(54) METHOD AND SYSTEM FOR MANAGING RESOURCES USING PREDICTIVE ANALYTICS

(71) Applicant: JPMorgan Chase Bank, N.A., New York, NY (US)

(72) Inventors: Luke STORRIE, Christchurch (GB); Frank VAN HOOF, Ringwood (GB); Zoe BERRY, Essex (GB); Rebecca CORNWELL, Dorset (GB); John MILLER, Bournemouth (GB); Erik RITSEMA, Dorset (GB); Smitha GANESH, Bangalore (IN); Ram CHINTA, Bangalore (IN); Santhosh ATCHUTUNI, Hyderabad (IN); Sophia BOTNAR, Surrey (GB); David A COLLINS, Dorset (GB)

(73) Assignee: JPMorgan Chase Bank, N.A., New York, NY (US)

(21) Appl. No.: 18/894,884

(22) Filed: Sep. 24, 2024

(30) Foreign Application Priority Data
Sep. 25, 2023 (IN) 202311064158

(51) Int. Cl. G06Q 10/0631; G06N 20/00; G06Q 10/04

(52) U.S. Cl. CPC G06Q 10/0631; G06N 20/00; G06Q 10/04

(57) ABSTRACT

A method for facilitating resource management by using predictive analytics is disclosed. The method includes aggregating, via an application programming interface, data from various sources, the data including end user data, resource data, and influential factor data; generating data products based on the aggregated data, the data products including a structured data set, an application, and a tool; training a first model by using the generated data products; determining predictive outputs by using the trained first model and the generated data products, each of the predictive outputs corresponding to a recommended action for management of resources; and publishing the predictive outputs to a downstream application.

### CROSS-REFERENCE TO RELATED APPLICATIONS

This application claims priority benefit from Indian application Ser. No. 202311064158, filed on Sep. 25, 2023 in the India Patent Office, which is hereby incorporated by reference in its entirety.

### BACKGROUND

### Field of the Disclosure

This technology generally relates to methods and systems for resource management, and more particularly to methods and systems for facilitating resource management by leveraging user behavioral data as well as predictive analytics via machine learning and/or artificial intelligence.

### Background Information

Many business entities rely on various types of resources such as, for example, organizational as well as computing resources to facilitate business operations and provide services for users. Often, utilization of these resources impacts different aspects of the business. Historically, implementations of conventional resource management techniques have resulted in varying degrees of success with respect to optimizing resource usage to capitalize on opportunities afforded by contemporary workplace environments.

One drawback of using the conventional resource management techniques is that in many instances, resource usage determinations require direct tracking of many different usage parameters such as, for example, occupancy by using large collections of motion sensors. As a result, effective resource management depends on large investments in complex networks of interrelated devices that connect and exchange data such as, for example, internet of things (IoT) devices. Additionally, due to difficulties associated with the tracking of certain parameters such as, for example, user lighting demands, workspaces may not be effectively designed for optimal usage.

The use of conventional resource management techniques also may lead to security issues, integrity issues, and unnecessary system resource usage issues. For example, the use of large numbers of motion sensors and/or other devices that are employed for obtaining data for usage tracking parameters may increase the risk of inconsistencies therebetween, thereby leading to an increase in the likelihood of errors. Moreover, the use of such devices may entail large system resource usage requirements, due to the need to receive, process, and transfer data among such systems. In addition, the use of disparate types of such devices may give rise to a reduction in computer functionality resulting from unintegrated software.

Therefore, there is a need for an effective resource management solution that leverages user behavioral data as well as predictive analytics via artificial intelligence and/or machine learning to intelligently identify, optimize, and orchestrate asset utilization.

### SUMMARY

The present disclosure, through one or more of its various aspects, embodiments, and/or specific features or sub-components, provides, inter alia, various systems, servers, devices, methods, media, programs, and platforms for facilitating resource management by leveraging user behavioral data as well as predictive analytics via machine learning and/or artificial intelligence.

According to an aspect of the present disclosure, a method for facilitating resource management by using predictive analytics is disclosed. The method is implemented by at least one processor. The method may include: aggregating, by the at least one processor via an application programming interface, data from at least one source, the data including at least one from among end user data, resource data, and influential factor data; generating, by the at least one processor, at least one data product based on the aggregated data, the at least one data product including at least one from among a structured data set, an application, and a tool; training, by the at least one processor, at least one first model by using the generated at least one data product; determining, by the at least one processor, at least one predictive output by using the trained at least one first model and the generated at least one data product, each of the at least one predictive output corresponding to a recommended action for management of at least one resource; and publishing, by the at least one processor, the at least one predictive output to a downstream application.

The method may further include: identifying, by the at least one processor using at least one second model, at least one behavioral segment based on the end user data, each of the at least one behavioral segment relating to a grouping of a plurality of end users based on at least one shared attribute; and identifying, by the at least one processor using the at least one second model, at least one preference characteristic for each of the at least one behavioral segment based on the end user data.

The method may further include: determining, by the at least one processor using at least one third model, at least one usage forecast based on the at least one behavioral segment, the corresponding at least one preference characteristic, the resource data, the influential factor data, and at least one predetermined criterion; and determining, by the at least one processor, at least one cost allocation for each of the at least one usage forecast. The at least one predetermined criterion may include at least one from among an organizational criterion and a user criterion.

Each of the at least one first model, the at least one second model, and the at least one third model may include at least one from among a large language model, a deep learning model, a neural network model, a natural language processing model, a machine learning model, a mathematical model, and a process model.

The at least one predictive output may include at least one from among synthetic sensor data, resource design data, resource organization data, and resource load balancing data, the resource load balancing data relating to an optimization of at least one resource based on usage demand and cost.

The method may further include identifying, by the at least one processor using the at least one first model, at least one data theme for each of the at least one resource. Each of the at least one data theme may include an impact determination for the at least one resource and a corresponding listing of at least one contributing metric.

The end user data may include at least one from among a workplace endpoint that relates to an end user, badge swipe data that relates to the end user, meeting metadata that relates to the end user, email metadata that relates to the end user, instant messaging data that relates to the end user, telephonic call metadata that relates to the end user, video conferencing metadata that relates to the end user, travel pattern data that relates to the end user, meeting room usage data that relates to the end user, and application usage data that relates to the end user.

The resource data may include at least one from among building capacity data that relates to an end user, existing booking data that relates to the end user, desk availability data that relates to the end user, planned meeting data that relates to the end user, manager in-office data that relates to the end user, co-worker in-office data that relates to the end user, and expected in-office time data that relates to the end user.

The influential factor data may include at least one from among distance-to-office data that relates to an end user, weather data that relates to the end user, traffic condition data that relates to the end user, internal/first-party event data that relates to the end user, and external/third-party event data that relates to the end user.

According to another embodiment, a computing apparatus for facilitating resource management by using predictive analytics is provided. The computing apparatus includes a processor; a memory; a display; and a communication interface coupled to each of the processor, the memory, and the display. The processor is configured to: aggregate, via an application programming interface, data from at least one source, the data including at least one from among end user data, resource data, and influential factor data; generate at least one data product based on the aggregated data, the at least one data product including at least one from among a structured data set, an application, and a tool; train at least one first model by using the generated at least one data product; determine at least one predictive output by using the trained at least one first model and the generated at least one data product, each of the at least one predictive output corresponding to a recommended action for management of at least one resource; and publish the at least one predictive output to a downstream application.

The processor may be further configured to: identify, by using at least one second model, at least one behavioral segment based on the end user data, each of the at least one behavioral segment relating to a grouping of a plurality of end users based on at least one shared attribute; and identify, by using the at least one second model, at least one preference characteristic for each of the at least one behavioral segment based on the end user data.

The processor may be further configured to: determine, by using at least one third model, at least one usage forecast based on the at least one behavioral segment, the corresponding at least one preference characteristic, the resource data, the influential factor data, and at least one predetermined criterion; and determine at least one cost allocation for each of the at least one usage forecast. The at least one predetermined criterion may include at least one from among an organizational criterion and a user criterion.

Each of the at least one first model, the at least one second model, and the at least one third model may include at least one from among a large language model, a deep learning model, a neural network model, a natural language processing model, a machine learning model, a mathematical model, and a process model.

The at least one predictive output may include at least one from among synthetic sensor data, resource design data, resource organization data, and resource load balancing data, the resource load balancing data relating to an optimization of at least one resource based on usage demand and cost.

The processor may further configured to identify, by using the at least one first model, at least one data theme for each of the at least one resource. Each of the at least one data theme may include an impact determination for the at least one resource and a corresponding listing of at least one contributing metric.

The end user data may include at least one from among a workplace endpoint that relates to an end user, badge swipe data that relates to the end user, meeting metadata that relates to the end user, email metadata that relates to the end user, instant messaging data that relates to the end user, telephonic call metadata that relates to the end user, video conferencing metadata that relates to the end user, travel pattern data that relates to the end user, meeting room usage data that relates to the end user, and application usage data that relates to the end user.

The resource data may include at least one from among building capacity data that relates to an end user, existing booking data that relates to the end user, desk availability data that relates to the end user, planned meeting data that relates to the end user, manager in-office data that relates to the end user, co-worker in-office data that relates to the end user, and expected in-office time data that relates to the end user.

The influential factor data may include at least one from among distance-to-office data that relates to an end user, weather data that relates to the end user, traffic condition data that relates to the end user, internal/first-party event data that relates to the end user, and external/third-party event data that relates to the end user.

According to yet another embodiment, a non-transitory computer readable storage medium storing instructions for facilitating resource management by using predictive analytics is provided. The storage medium includes a set of executable code which, when executed by a processor, causes the processor to: aggregate, via an application programming interface, data from at least one source, the data including at least one from among end user data, resource data, and influential factor data; generate at least one data product based on the aggregated data, the at least one data product including at least one from among a structured data set, an application, and a tool; train at least one first model by using the generated at least one data product; determine at least one predictive output by using the trained at least one first model and the generated at least one data product, each of the at least one predictive output corresponding to a recommended action for management of at least one resource; and publish the at least one predictive output to a downstream application.

When executed, the executable code may further cause the processor to: identify, by using at least one second model, at least one behavioral segment based on the end user data, each of the at least one behavioral segment relating to a grouping of a plurality of end users based on at least one shared attribute; and identify, by using the at least one second model, at least one preference characteristic for each of the at least one behavioral segment based on the end user data.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system, according to an embodiment.

FIG. 2 illustrates a diagram of a network environment, according to an embodiment.

FIG. 3 shows a system for implementing a method for facilitating resource management by leveraging user behavioral data as well as predictive analytics via machine learning and/or artificial intelligence, according to an embodiment.

FIG. 4 is a flowchart of a process for implementing a method for facilitating resource management by leveraging user behavioral data as well as predictive analytics via machine learning and/or artificial intelligence, according to an embodiment.

FIG. 5 is a flow diagram of a process for implementing a method for facilitating resource management by leveraging user behavioral data as well as predictive analytics via machine learning and/or artificial intelligence, according to an embodiment.

FIG. 6 is a smart building flow diagram of a process for implementing a method for facilitating resource management by leveraging user behavioral data as well as predictive analytics via machine learning and/or artificial intelligence, according to an embodiment.

### DETAILED DESCRIPTION

Through one or more of its various aspects, embodiments and/or specific features or sub-components of the present disclosure are intended to bring out one or more of the advantages as specifically described above and noted below.

The present inventive concept may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As disclosed herein, a system or method improves security, reduces system errors due to heterogeneous third-party systems, and facilitates a more efficient use of system resources by: aggregating, via an application programming interface, data from at least one source, the data including at least one from among end user data, resource data, and influential factor data; generating at least one data product based on the aggregated data, the at least one data product including at least one from among a structured data set, an application, and a tool; training at least one first model by using the generated at least one data product; determining at least one predictive output by using the trained at least one first model and the generated at least one data product, each of the at least one predictive output corresponding to a recommended action for management of at least one resource; and publishing the at least one predictive output to a downstream application. In this manner, the system is able to improve security, reduce system errors due to heterogeneous third-party systems, and facilitate a more efficient use of system resources by performing each of the above steps in a secure and easy-to-use single platform, without a reliance upon multiple third-party systems.

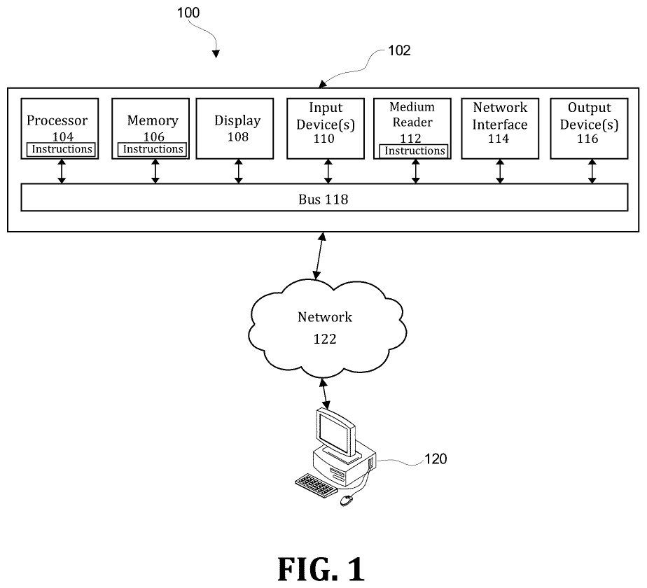

FIG. 1 is a system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning system (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in a non-limiting embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating resource management by leveraging user behavioral data as well as predictive analytics via machine learning and/or artificial intelligence.

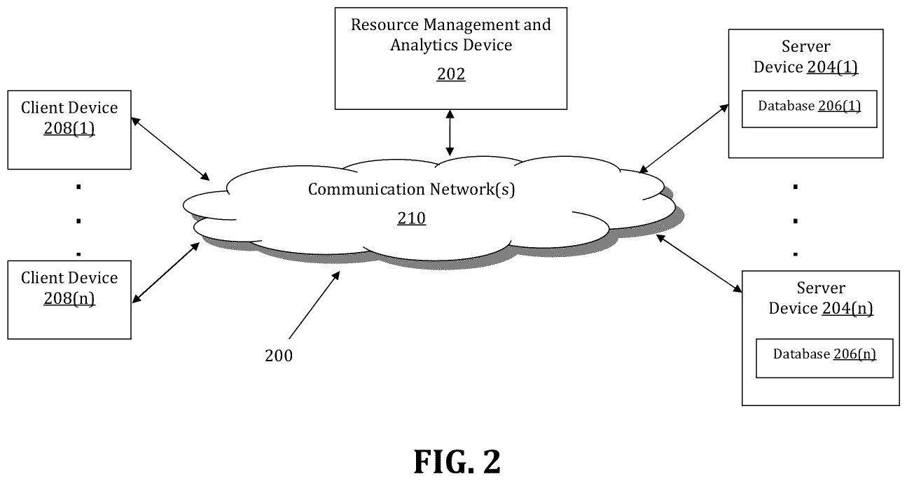

Referring to FIG. 2, a schematic of a network environment 200 for implementing a method for facilitating resource management by leveraging user behavioral data as well as predictive analytics via machine learning and/or artificial intelligence is illustrated. In an embodiment, the method is executable on any networked computer platform, such as, for example, a personal computer (PC).

The method for facilitating resource management by leveraging user behavioral data as well as predictive analytics via machine learning and/or artificial intelligence may be implemented by a Resource Management and Analytics (RMA) device 202. The RMA device 202 may be the same or similar to the computer system 102 as described with respect to FIG. 1. The RMA device 202 may store one or more applications that can include executable instructions that, when executed by the RMA device 202, cause the RMA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the RMA device 202 itself, may be located in virtual server(s) running in a cloud-based computing environment rather than being tied to one or more specific physical network computing devices. Also, the application(s) may be running in one or more virtual machines (VMs) executing on the RMA device 202. Additionally, in one or more embodiments of this technology, virtual machine(s) running on the RMA device 202 may be managed or supervised by a hypervisor.

In the network environment 200 of FIG. 2, the RMA device 202 is coupled to a plurality of server devices 204(1)-204(n) that hosts a plurality of databases 206(1)-206(n), and also to a plurality of client devices 208(1)-208(n) via communication network(s) 210. A communication interface of the RMA device 202, such as the network interface 114 of the computer system 102 of FIG. 1, operatively couples and communicates between the RMA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the RMA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and RMA devices that efficiently implement a method for facilitating resource management by leveraging user behavioral data as well as predictive analytics via machine learning and/or artificial intelligence.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The RMA device 202 may be a standalone device or integrated with one or more other devices or apparatuses, such as one or more of the server devices 204(1)-204(n), for example. In one particular example, the RMA device 202 may include or be hosted by one of the server devices 204(1)-204(n), and other arrangements are also possible. Moreover, one or more of the devices of the RMA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the RMA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to end user data, resource data, influential factor data, data products, data sets, applications, tools, machine learning models, and predictive outputs.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the RMA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the RMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the RMA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the RMA device 202, the server devices 204(1)-204(n), or the client devices 208(1)-208(n), for example, may be configured to operate as virtual instances on the same physical machine. In other words, one or more of the RMA device 202, the server devices 204(1)-204(n), or the client devices 208(1)-208(n) may operate on the same physical device rather than as separate devices communicating through communication network(s) 210. Additionally, there may be more or fewer RMA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

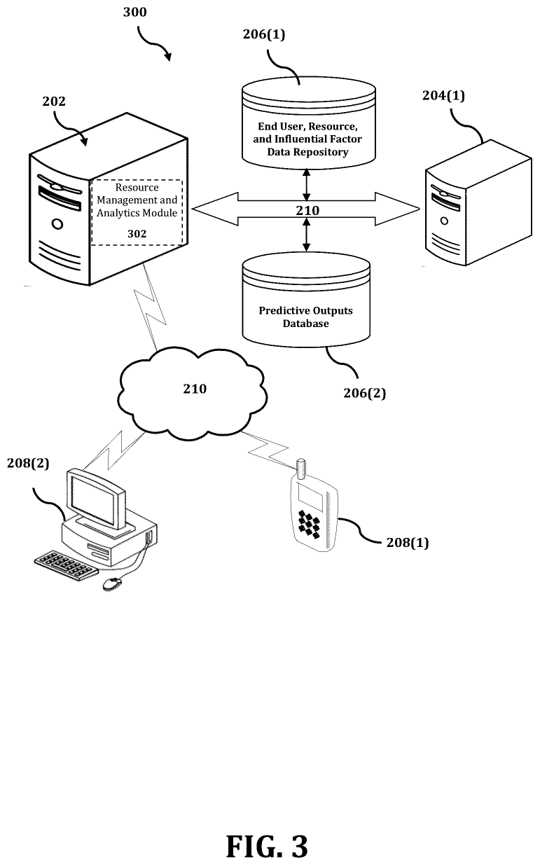

The RMA device 202 is described and shown in FIG. 3 as including a resource management and analytics module 302, although it may include other rules, policies, modules, databases, or applications, for example. As will be described below, the resource management and analytics module 302 is configured to implement a method for facilitating resource management by leveraging user behavioral data as well as predictive analytics via machine learning and/or artificial intelligence.

A system 300 for implementing a mechanism for facilitating resource management by leveraging user behavioral data as well as predictive analytics via machine learning and/or artificial intelligence by utilizing the network environment of FIG. 2 is shown as being executed in FIG. 3. Specifically, a first client device 208(1) and a second client device 208(2) are illustrated as being in communication with RMA device 202. In this regard, the first client device 208(1) and the second client device 208(2) may be “clients” of the RMA device 202 and are described herein as such. Nevertheless, it is to be known and understood that the first client device 208(1) and/or the second client device 208(2) need not necessarily be “clients” of the RMA device 202, or any entity described in association therewith herein. Any additional or alternative relationship may exist between either or both of the first client device 208(1) and the second client device 208(2) and the RMA device 202, or no relationship may exist.

Further, RMA device 202 is illustrated as being able to access an end user, resource, and influential factor data repository 206(1) and a predictive outputs database 206(2). The resource management and analytics module 302 may be configured to access these databases for implementing a method for facilitating resource management by leveraging user behavioral data as well as predictive analytics via machine learning and/or artificial intelligence.

The first client device 208(1) may be, for example, a smart phone. Of course, the first client device 208(1) may be any additional device described herein. The second client device 208(2) may be, for example, a PC. Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the RMA device 202 via broadband or cellular communication. Of course, these embodiments are merely exemplary and are not limiting or exhaustive.

As may be described below, the resource management and analytics module 302 may be configured to: aggregate, via an application programming interface, data from at least one source, the data including at least one from among end user data, resource data, and influential factor data; generate at least one data product based on the aggregated data, the at least one data product including at least one from among a structured data set, an application, and a tool; train at least one first model by using the generated at least one data product; determine at least one predictive output by using the trained at least one first model and the generated at least one data product, each of the at least one predictive output corresponding to a recommended action for management of at least one resource; and publish the at least one predictive output to a downstream application, but the disclosure is not limited thereto.

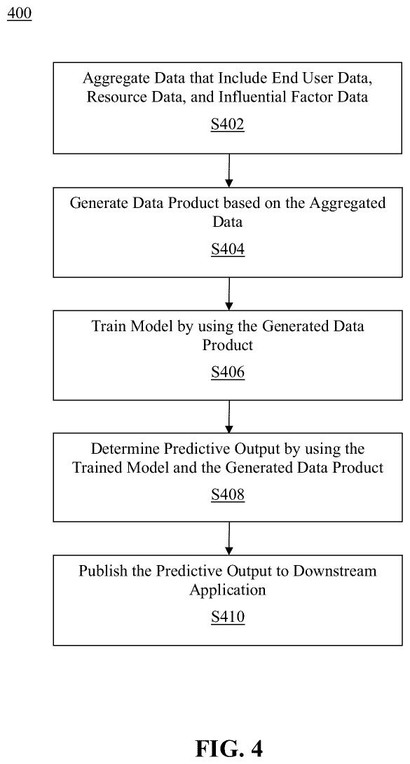

Upon being started, the resource management and analytics module 302 executes a process for facilitating resource management by leveraging user behavioral data as well as predictive analytics via machine learning and/or artificial intelligence. A process for facilitating resource management by leveraging user behavioral data as well as predictive analytics via machine learning and/or artificial intelligence is generally indicated at flowchart 400 in FIG. 4.

In the process 400 of FIG. 4, at step S402, data may be aggregated from a variety of sources. The data may be aggregated from the sources via an application programming interface. In an embodiment, the data may include at least one from among end user data, resource data, and influential factor data. The data may relate to behavioral data that provides information on the range of actions and mannerisms made by individuals, organisms, systems, or artificial entities in an environment such as, for example, a workplace environment. The systems may include other systems, organisms, as well as inanimate physical environments such as, for example, office equipment. The behavioral data may describe behavioral traits that are usable to determine the actions and mannerisms.

In another embodiment, the end user data may include any combination of structured and unstructured data that provides information relating to an end user. The end user may relate to an individual who ultimately uses and/or is intended to ultimately use a system in an environment such as, for example, the workplace environment. The end user data may include information that relates to at least one from among workplace endpoints, badge swipe data, meeting metadata, email metadata, instant messaging metadata, telephonic call metadata, video conferencing metadata, travel pattern data, desk usage data, meeting room usage data, and application usage data.

In another embodiment, the resource data may include any combination of structured and unstructured data that provide information relating to managed resources. The managed resources may include at least one from among an organizational resource and a computing resource. The organizational resource may relate to tangible assets that the end user may interact with in a workplace environment such as, for example, desks and chairs, as well as intangible assets that are usable by the end user such as, for example, meeting schedules and desk availabilities. The computing resource may relate to tangible computing assets that the end user may interact with in a workplace environment such as, for example, electronic devices for the storing and processing of data, as well as intangible computing assets that are usable by the end user such as, for example, processing bandwidth in a cloud computing environment. The resource data may include information that relates to at least one from among building capacity data, reference data, existing booking data, desk availability data, planned meeting data, manager in-office data, co-worker in-office data, and expected in-office time data.

In another embodiment, the influential factor data may include any combination of structured and unstructured data that provide information relating to factors that influence the end user. The factors may relate to circumstances that have a capacity to affect the character, development, and/or behavior of the end user. The factors may affect the end user in indirect and/or intangible ways. The influential factor data may include information that relates to at least one from among distance to office data, weather data, transportation data, traffic condition data, internal/first-party event data, and external/third-party event data.

In another embodiment, the data may be aggregated from at least one from among a first-party source and a third-party source. The first-party source may relate to internal data sources of an enterprise such as, for example, a business entity associated with the end user. Internal data may be aggregated from any combination of internal data persistence systems such as, for example, human resource systems as well as internal data collection systems such as, for example, internet of things (IoT) systems that include a network of sensors.

The third-party sources may relate to external data sources such as, for example, data aggregators that may provide external data to the enterprise. The external data may include environmental data such as, for example, traffic data as well as end user related data such as, for example, social media data. The data may be automatically aggregated from the sources by using an application programming interface that serves as a software intermediary between computing components. The application programming interface may relate to a set of definitions and protocols that define interactions between the computing components.

At step S404, data products may be generated based on the aggregated data. The data products may include at least one from among a structured data set, an application, and a tool. In an exemplary embodiment, the data products may use the aggregated data to provide insight and improve decision-making processes. The data products may relate to reusable assets that bundle the aggregated data together with everything needed to make the aggregated data usable. The reusable assets may correspond to self-contained data solutions that include the aggregated data.

In another embodiment, the applications described in the present disclosure may include at least one from among a monolithic application and a microservice application. The monolithic application may describe a single-tiered software application where the user interface and data access code are combined into a single program from a single platform. The monolithic application may be self-contained and independent from other computing applications.

In another embodiment, a microservice application may include a unique service and a unique process that communicates with other services and processes over a network to fulfill a goal. The microservice application may be independently deployable and organized around business capabilities. In another embodiment, the microservices may relate to a software development architecture such as, for example, an event-driven architecture made up of event producers and event consumers in a loosely coupled choreography. The event producer may detect or sense an event such as, for example, a significant occurrence or change in state for system hardware or software and represent the event as a message. The event message may then be transmitted to the event consumer via event channels for processing.

In another embodiment, the event-driven architecture may include a distributed data streaming platform for the publishing, subscribing, storing, and processing of event streams in real time. As will be appreciated by a person of ordinary skill in the art, each microservice in a microservice choreography may perform corresponding actions independently and may not require any external instructions.

In another embodiment, microservices may relate to a software development architecture such as, for example, a service-oriented architecture which arranges a complex application as a collection of coupled modular services. The modular services may include small, independently versioned, and scalable customer-focused services with specific business goals. The services may communicate with other services over standard protocols with well-defined interfaces. In another embodiment, the microservices may utilize technology-agnostic communication protocols such as, for example, a Hypertext Transfer Protocol (HTTP) to communicate over a network and may be implemented by using different programming languages, databases, hardware environments, and software environments.

At step S406, a model may be trained by using the generated data products. The model may correspond to a first model in a series of models that are usable to facilitate actions consistent with present disclosures. The model may relate to machine learning and/or artificial intelligence models.

In another embodiment, the series of models may include at least one from among a large language model, a deep learning model, a neural network model, a natural language processing model, a machine learning model, a mathematical model, a process model, and a data model. The language model may also include stochastic models such as, for example, a Markov model that is used to model randomly changing systems. In stochastic models, the future states of a system may be assumed to depend only on the current state of the system.

In another embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another embodiment, machine learning analytical techniques may include unsupervised learning algorithms such as, for example, Apriori algorithm analysis, K-means clustering analysis, etc. In another embodiment, machine learning analytical techniques may include reinforcement learning algorithms such as, for example, Markov Decision Process analysis, etc.

In another embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another embodiment, the machine learning process may include a neural network that relates to at least one from among an artificial neural network and a simulated neural network. The neural network may correspond to a technique in artificial intelligence that teaches computers to process data by using interconnected processing nodes and/or artificial neurons. The neural network may relate to a type of machine learning such as, for example, deep learning that uses interconnected nodes and/or artificial neurons in a layered structure to transform inputs for predictive analytics.

In another embodiment, the model may include training models such as, for example, a machine learning model which is generated to be further trained on additional data. Once the training model has been sufficiently trained, the training model may be deployed onto various connected systems to be utilized. In another embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another embodiment, the training model may be operable, i.e., actively utilized by an organization, while continuing to be trained using new data. In another embodiment, the models may be generated using at least one from among an artificial neural network technique, a decision tree technique, a support vector machines technique, a Bayesian network technique, and a genetic algorithms technique.

In another embodiment, the large language model may relate to a trained deep-learning model that understands and generates text in a human-like fashion. The large language model may recognize, summarize, translate, predict, and generate various types of text as well as content based on knowledge gained from massive data sets. In another embodiment, the large language model may correspond to a language model that consists of a neural network with many parameters such as, for example, weights. The language model may be trained on large quantities of unlabeled and labeled text by using self-supervised learning or semi-supervised learning. The trained language model may be usable to capture syntax and semantics of human language.

In another embodiment, the natural language processing model may correspond to a plurality of natural language processing techniques. The natural language processing techniques may include at least one from among a sentiment analysis technique, a named entity recognition technique, a summarization technique, a topic modeling technique, a text classification technique, a keyword extraction technique, and a lemmatization and stemming technique. As will be appreciated by a person of ordinary skill in the art, natural language processing may relate to computer processing and analyzing of large quantities of natural language data.

At step S408, predictive outputs may be determined by using the trained model and the generated data products. Each of the predictive outputs may correspond to a recommended action for management of resources. For example, the predictive outputs may be usable by a real estate service to intelligently design an office building and allocate resources based on end user behaviors.

In an embodiment, the predictive outputs may include at least one from among synthetic sensor data, resource design data, resource organization data, and resource load balancing data. The synthetic sensor data may relate to the generation of IOT like, sensor data outcomes based on forecasted behaviors to optimize services such as, for example, lighting services and heating services. The sensor data outcomes may be determined based on forecasted behaviors without a physical sensor device. The resource design data may relate to prediction of required demands for resources such as, for example, offices, desks, floor spaces, and ratios of different space types to facilitate building design.

Similarly, the resource organization data may relate to workforce occupation information that influences floor map designs for optimal end user placement. For example, occupation information may influence floor map design to co-locate end users for optimal work experiences. The resource load balancing data may include optimization information to load balance and/or redistribute floor demand based on behavioral usage and influencing factors. The resource load balancing data may relate to an optimization of resources based on usage demands and/or costs.

At step S410, the predictive outputs may be published to downstream applications. The predictive outputs may be provided to the downstream applications via any communication interface such as, for example, an application programing interface. The predictive outputs may be provided to the downstream applications to initiate the recommended actions and/or provide information for the management of resources consistent with present disclosures. In another embodiment, the predictive outputs may be packaged into a vendor sales package. The vendor sales package may be independently contained to provide information for the management of resources consistent with present disclosures.

In another embodiment, behavioral segments may be identified based on the end user data. Each of the behavioral segments may relate to a grouping of end users based on shared attributes. The shared attributes may include at least one from among working preferences, seating preferences, and behavioral preferences. The working preferences may describe a work style of the end user such as, for example, a preference for highly collaborative work or a preference for more focused work. The seating preferences may describe an environmental preference such as, for example, a preference for access to natural light. The behavioral preferences may describe a preferred range of actions and mannerisms of the end user such as, for example, a tendency to meet in person when possible and/or a desire for close proximity to a manager.

The behavioral segments may be identified by using a model to facilitate management of resources in a workplace environment. For example, the model may be usable to identify behavioral segments of end users to facilitate smart building designs that effectively allocates resources. The model may correspond to a second model in a series of models that are usable to facilitate actions consistent with present disclosures. The model may include a behavioral segmentation model that is usable to categorize and group end users based the shared attributes identified from the end user data.

Then, preference characteristics may also be identified for each of the behavioral segments based on the end user data. The preference characteristics may relate to secondary behavioral descriptors that provide context for each of the behavioral segments. The preference characteristics may correspond to and/or augment the grouping of end users. For example, the preference characteristics may contextualize the desired highly collaborative work environment of a behavioral segment. Consistent with present disclosures, the preference characteristics may be identified by using a model such as, for example, the second model.

In another embodiment, usage forecasts may be determined based on the behavioral segments, the corresponding preference characteristics, the resource data, the influential factor data, and predetermined criteria. The usage forecasts may relate to a predicted usage of resources and assets such as, for example, an office building by the grouping of end users. The usage forecasts may include information that relates to at least one from among real estate utilization, smart resource allocations, air conditioning settings, and IOT type utilization data based on predictions.

The usage forecasts may be identified by using a model to facilitate management of resources in a workplace environment. The model may correspond to a third model in a series of models that are usable to facilitate actions consistent with present disclosures. Then, cost allocations may be determined for each of the usage forecasts. Cost allocations and tier services may be facilitated based on expected utilization of the resources and/or assets.

In another embodiment, the predetermined criteria may include at least one from among an organizational criterion and a user criterion. The predetermined criteria may be received as inputs via a graphical user interface to facilitate the allocation of resources. The organizational criterion may relate to business inputs that define preferences and/or policies of an organization. The organizational criterion may include at least one from among a preference for increased collaboration, a preference for increased networking, a guideline for new joiner integration, a preference for line-of-business organization, a preference for seating arrangement, and a guidance for in-office expectations. Similarly, the user criterion may relate to opt-in user inputs that define preferences and/or requirements of the end user. The user criterion may include at least one from among a preference for different seats per day, a preference for maximizing in-person meetings, and a preference for networking in the workplace.

In another embodiment, data themes may be identified for each of the resources. The data themes may be identified by using a model to facilitate management of resources in a workplace environment. The model may correspond to a fourth model in a series of models that are usable to facilitate actions consistent with present disclosures. The data themes may include an impact determination for the resources and a corresponding listing of contributing metrics. The impact determination may be presented in natural language format to provide resource impact information. The data themes may include at least one from among a desk demand and volatility theme, a collaboration demand theme, a building activity theme, a noise indicators theme, a people conformity theme, a people and management theme, a building desirability theme, a financials theme, and a projects/work requests theme.

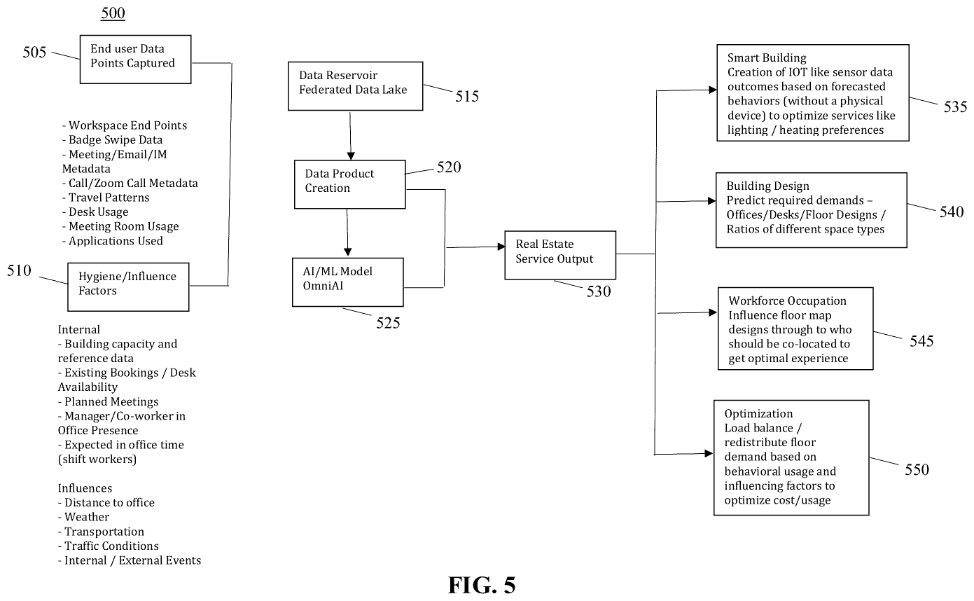

FIG. 5 is a flow diagram 500 of a process for implementing a method for facilitating resource management by leveraging user behavioral data as well as predictive analytics via machine learning and/or artificial intelligence, according to an embodiment. In FIG. 5, a solution is provided that uses behavioral data to intelligently identity resource and/or asset utilization to facilitate resource management.

As illustrated in FIG. 5, end user data points 505 as well as hygiene/influence factors data 510 may be captured and persisted in a data reservoir 515 such as, for example, a federated data lake, similarly as illustrated in FIG. 4 at step S402. At 520, similarly as illustrated in FIG. 4 at step S404, the captured data may be usable to generate data products, which are also maintained in the federated data lake. At 525, similarly as illustrated in FIG. 4 at step S406, the data products may be usable to generate and train machine learning models consistent with present disclosures. Then, at 530, similarly as illustrated in FIG. 4 at steps S408 and S410, the trained machine learning models may use the data products to provide predictive outputs for downstream applications such as, for example, a real estate service. The predictive outputs may include information that facilitates the design of intelligent workspaces/smart buildings 535 and the management of resources such as, for example, worker resources and computing resources, including building design information 540, workforce occupation information 545, and optimization information 550.

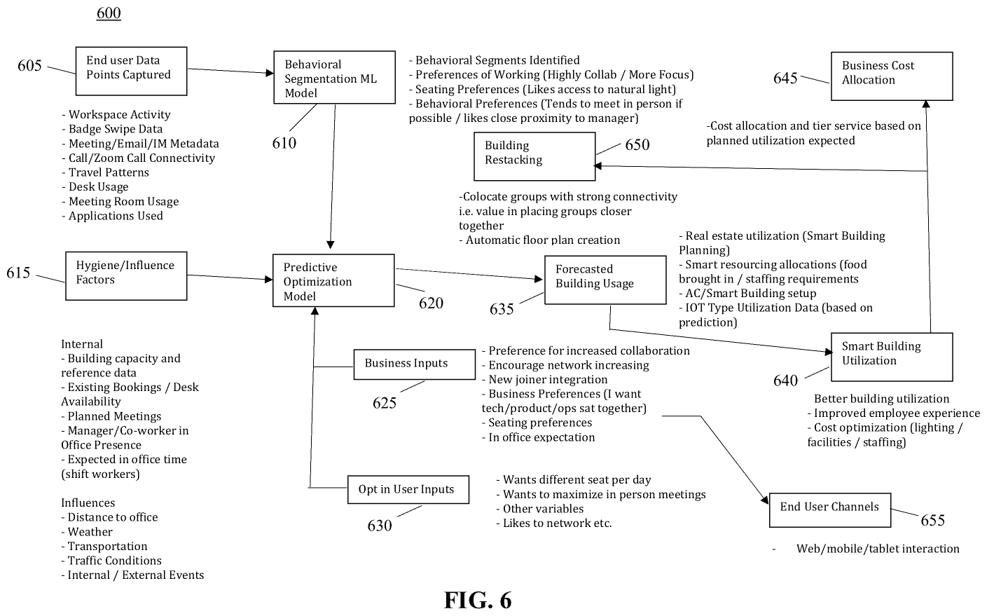

FIG. 6 is a smart building flow diagram 600 of a process for implementing a method for facilitating resource management by leveraging user behavioral data as well as predictive analytics via machine learning and/or artificial intelligence, according to an embodiment. In FIG. 6, a solution is provided that uses behavioral data to intelligently identity resource and/or asset utilization to facilitate resource management.

As illustrated in FIG. 6, similarly as illustrated in FIG. 4 at step S402, end user data points 605 may be captured for use by a machine learning model such as, for example, a behavioral segmentation model 610. The behavioral segmentation model 610 may identity behavioral segments as well as preferences for a grouping of end users. Similarly, hygiene/influence factors data 615 may be captured for use by a machine learning model such as, for example, a predictive optimization model 620. The predictive optimization model 620 may use the hygiene/influence factors data 615, the behavioral segments data, and the preferences together with business inputs 625 and opt-in user inputs 630 to generate forecasted building usage information 635, similarly as illustrated in FIG. 4 at step S408. The forecasted building usage information 635 may be usable to facilitate smart building utilization designs 640. Then, business cost allocations 645 may be determined based on the smart building utilization designs 640 to facilitate building restacking 650. Then, similarly as illustrated in FIG. 4 at step S410, the business inputs 625 and the opt-in user inputs 630 may be made available to end users via end user channels 655 in order to facilitate end user interactions via web, mobile, and/or tablet user interfaces.

Accordingly, with this technology, an optimized process for facilitating resource management by leveraging user behavioral data as well as predictive analytics via machine learning and/or artificial intelligence is disclosed.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating resource management by using predictive analytics, the method being implemented by at least one processor, the method comprising:
aggregating, by the at least one processor via an application programming interface, data from at least one source, the data including at least one from among end user data, resource data, and influential factor data;
generating, by the at least one processor, at least one data product based on the aggregated data, the at least one data product including at least one from among a structured data set, an application, and a tool;
training, by the at least one processor, at least one first model by using the generated at least one data product;
determining, by the at least one processor, at least one predictive output by using the trained at least one first model and the generated at least one data product, each of the at least one predictive output corresponding to a recommended action for management of at least one resource; and
publishing, by the at least one processor, the at least one predictive output to a downstream application.

2. The method of claim 1, further comprising:
identifying, by the at least one processor using at least one second model, at least one behavioral segment based on the end user data, each of the at least one behavioral segment relating to a grouping of a plurality of end users based on at least one shared attribute; and
identifying, by the at least one processor using the at least one second model, at least one preference characteristic for each of the at least one behavioral segment based on the end user data.

3. The method of claim 2, further comprising:
determining, by the at least one processor using at least one third model, at least one usage forecast based on the at least one behavioral segment, the corresponding at least one preference characteristic, the resource data, the influential factor data, and at least one predetermined criterion; and
determining, by the at least one processor, at least one cost allocation for each of the at least one usage forecast,
wherein the at least one predetermined criterion includes at least one from among an organizational criterion and a user criterion.

4. The method of claim 3, wherein each of the at least one first model, the at least one second model, and the at least one third model includes at least one from among a large language model, a deep learning model, a neural network model, a natural language processing model, a machine learning model, a mathematical model, and a process model.

5. The method of claim 1, wherein the at least one predictive output includes at least one from among synthetic sensor data, resource design data, resource organization data, and resource load balancing data, the resource load balancing data relating to an optimization of at least one resource based on usage demand and cost.

6. The method of claim 1, further comprising:
identifying, by the at least one processor using the at least one first model, at least one data theme for each of the at least one resource,
wherein each of the at least one data theme includes an impact determination for the at least one resource and a corresponding listing of at least one contributing metric.

7. The method of claim 1, wherein the end user data includes at least one from among a workplace endpoint that relates to an end user, badge swipe data that relates to the end user, meeting metadata that relates to the end user, email metadata that relates to the end user, instant messaging data that relates to the end user, telephonic call metadata that relates to the end user, video conferencing metadata that relates to the end user, travel pattern data that relates to the end user, meeting room usage data that relates to the end user, and application usage data that relates to the end user.

8. The method of claim 1, wherein the resource data includes at least one from among building capacity data that relates to an end user, existing booking data that relates to the end user, desk availability data that relates to the end user, planned meeting data that relates to the end user, manager in-office data that relates to the end user, co-worker in-office data that relates to the end user, and expected in-office time data that relates to the end user.

9. The method of claim 1, wherein the influential factor data includes at least one from among distance-to-office data that relates to an end user, weather data that relates to the end user, traffic condition data that relates to the end user, internal/first-party event data that relates to the end user, and external/third-party event data that relates to the end user.

10. A computing apparatus for facilitating resource management by using predictive analytics, the computing apparatus comprising:
a processor;
a memory; and
a communication interface coupled to each of the processor and the memory,
wherein the processor is configured to:
aggregate, via an application programming interface, data from at least one source, the data including at least one from among end user data, resource data, and influential factor data;
generate at least one data product based on the aggregated data, the at least one data product including at least one from among a structured data set, an application, and a tool;
train at least one first model by using the generated at least one data product;
determine at least one predictive output by using the trained at least one first model and the generated at least one data product, each of the at least one predictive output corresponding to a recommended action for management of at least one resource; and
publish the at least one predictive output to a downstream application.

11. The computing apparatus of claim 10, wherein the processor is further configured to:
identify, by using at least one second model, at least one behavioral segment based on the end user data, each of the at least one behavioral segment relating to a grouping of a plurality of end users based on at least one shared attribute; and
identify, by using the at least one second model, at least one preference characteristic for each of the at least one behavioral segment based on the end user data.

12. The computing apparatus of claim 11, wherein the processor is further configured to:
determine, by using at least one third model, at least one usage forecast based on the at least one behavioral segment, the corresponding at least one preference characteristic, the resource data, the influential factor data, and at least one predetermined criterion; and
determine at least one cost allocation for each of the at least one usage forecast,
wherein the at least one predetermined criterion includes at least one from among an organizational criterion and a user criterion.

13. The computing apparatus of claim 12, wherein each of the at least one first model, the at least one second model, and the at least one third model includes at least one from among a large language model, a deep learning model, a neural network model, a natural language processing model, a machine learning model, a mathematical model, and a process model.

14. The computing apparatus of claim 10, wherein the at least one predictive output includes at least one from among synthetic sensor data, resource design data, resource organization data, and resource load balancing data, the resource load balancing data relating to an optimization of at least one resource based on usage demand and cost.

15. The computing apparatus of claim 10, wherein the processor is further configured to:
identify, by using the at least one first model, at least one data theme for each of the at least one resource,
wherein each of the at least one data theme includes an impact determination for the at least one resource and a corresponding listing of at least one contributing metric.

16. The computing apparatus of claim 10, wherein the end user data includes at least one from among a workplace endpoint that relates to an end user, badge swipe data that relates to the end user, meeting metadata that relates to the end user, email metadata that relates to the end user, instant messaging data that relates to the end user, telephonic call metadata that relates to the end user, video conferencing metadata that relates to the end user, travel pattern data that relates to the end user, meeting room usage data that relates to the end user, and application usage data that relates to the end user.

17. The computing apparatus of claim 10, wherein the resource data includes at least one from among building capacity data that relates to an end user, existing booking data that relates to the end user, desk availability data that relates to the end user, planned meeting data that relates to the end user, manager in-office data that relates to the end user, co-worker in-office data that relates to the end user, and expected in-office time data that relates to the end user.

18. The computing apparatus of claim 10, wherein the influential factor data includes at least one from among distance-to-office data that relates to an end user, weather data that relates to the end user, traffic condition data that relates to the end user, internal/first-party event data that relates to the end user, and external/third-party event data that relates to the end user.

19. A non-transitory computer readable storage medium storing instructions for facilitating resource management by using predictive analytics, the storage medium comprising executable code which, when executed by a processor, causes the processor to:
aggregate, via an application programming interface, data from at least one source, the data including at least one from among end user data, resource data, and influential factor data;
generate at least one data product based on the aggregated data, the at least one data product including at least one from among a structured data set, an application, and a tool;
train at least one first model by using the generated at least one data product;
determine at least one predictive output by using the trained at least one first model and the generated at least one data product, each of the at least one predictive output corresponding to a recommended action for management of at least one resource; and
publish the at least one predictive output to a downstream application.

20. The storage medium of claim 19, wherein when executed, the executable code further causes the processor to:
identify, by using at least one second model, at least one behavioral segment based on the end user data, each of the at least one behavioral segment relating to a grouping of a plurality of end users based on at least one shared attribute; and
identify, by using the at least one second model, at least one preference characteristic for each of the at least one behavioral segment based on the end user data.
